(19) United States
(12) Patent Application Publication
(10) Pub. No.: US 2016/0073089 A1
(43) Pub. Date: Mar. 10, 2016

(54) METHOD FOR GENERATING 3D IMAGE AND ELECTRONIC APPARATUS USING THE SAME

(71) Applicant: Acer Incorporated, New Taipei City (TW)

(72) Inventors: Kuei-Ping Ting, New Taipei City (TW); Chao-Kuang Yang, New Taipei City (TW)

(21) Appl. No.: 14/530,844

(22) Filed: Nov. 3, 2014

(30) Foreign Application Priority Data
Sep. 4, 2014 (TW) 103130616

(51) Int. Cl. H04N 13/02; G06T 7/00; G02B 27/22

(52) U.S. Cl. CPC H04N 13/0235; G02B 27/22; G06T 7/0038; G06T 7/0085; G06T 2207/10012

(57) ABSTRACT

A method for generating a 3D image and an electronic apparatus using the same method are proposed. The method includes: capturing a plurality of images corresponding to a plurality of focal lengths, where there are a plurality of focal length differences between the focal lengths; selecting a reference image from the images, and taking the reference image as a 3D reference plane in a 3D space; performing an edge detection to each of the images according to a sharpness reference value to find at least one contour corresponding to the sharpness reference value in each of the images; arranging each of the images in the 3D space based on each of the focal length differences and the 3D reference plane; performing an interpolation operation between the at least one contour of each of the images to generate a 3D image.

### CROSS-REFERENCE TO RELATED APPLICATION

This application claims the priority benefit of Taiwan application serial no. 103130616, filed on Sep. 4, 2014. The entirety of the above-mentioned patent application is hereby incorporated by reference herein and made a part of this specification.

### BACKGROUND

1. Technical Field

The invention relates to a method for generating image and an electronic apparatus using the same, and particularly relates to a method for generating a three-dimensional (3D) image and an electronic apparatus using the same.

2. Related Art

In modern society, various smart products having a camera function have become an indispensable part of people's daily life. In order to satisfy consumer's increasing demand for taking pictures, many manufacturers are devoted to develop various camera and image processing applications such as skin beautifying, special effects, sticker adding, photo scene conversion and 2D to 3D image conversion, etc.

In the conventional 2D to 3D image conversion function, two cameras configured on a smart product are generally used to simultaneously capture two pictures, and a 3D image is generated based on the two pictures, though such mechanism is not suitable for the products having a single camera.

Moreover, in a conventional method for generating 3D image by using the product only having the single camera, the product captures a plurality of pictures of different viewing angles in a translation manner, and a binocular parallax is simulated through a horizontal distance between the pictures, so as to correspondingly generate the 3D image. However, such operation method is inconvenient for the user.

### SUMMARY

The invention is directed to a method for generating a three-dimensional (3D) image and an electronic apparatus using the same, by which the 3D image is generated according to a plurality of images corresponding to different focal lengths, such that a user is capable of obtaining the 3D image through a product only having a single camera.

The invention provides a method for generating a 3D image, which is adapted to an electronic apparatus. The method includes following steps. A plurality of images corresponding to a plurality of focal lengths are captured, where there are a plurality of focal length differences between the focal lengths. A reference image is selected from the images, and the reference image is taken as a 3D reference plane in a 3D space. An edge detection is performed to each of the images according to a sharpness reference value to find at least one contour corresponding to the sharpness reference value in each of the images. Each of the images in the 3D space is arranged based on each of the focal length differences and the 3D reference plane. An interpolation operation is performed between the at least one contour of each of the images to generate the 3D image.

The invention provides an electronic device, which is adapted to generate a 3D image. The electronic device includes an image capturing unit, a storage unit and a processing unit. The storage unit stores a plurality of modules. The processing unit is connected to the image capturing unit and the storage unit, and accesses and executes the modules. The modules include a capturing module, a selecting module, a detecting module, an arranging module and a generating module. The capturing module controls the image capturing unit to capture a plurality of images corresponding to a plurality of focal lengths, where there are a plurality of focal length differences between the focal lengths. The selecting module selects a reference image from the images, and takes the reference image as a 3D reference plane in a 3D space. The detecting module performs an edge detection to each of the images according to a sharpness reference value to find at least one contour corresponding to the sharpness reference value in each of the images. The arranging module arranges each of the images in the 3D space based on each of the focal length differences and the 3D reference plane. The generating module performs an interpolation operation between the at least one contour of each of the images to generate the 3D image.

According to the above descriptions, in the method for generating the 3D image and the electronic apparatus using the same of the invention, after a plurality of images corresponding to different focal lengths are obtained, the images are suitably arranged in the 3D space according to the focal lengths. Then, the electronic apparatus executes the edge detection on each of the images to find the contours of each of the images, and executes the interpolation operation between the contours of each of the images to generate the 3D image corresponding to the captured images.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic apparatus according to an embodiment of the invention.

FIG. 2 is a flowchart illustrating a method for generating a 3D image according to an embodiment of the invention.

FIG. 3A to FIG. 3F are schematic diagrams illustrating a process of generating a 3D image according to an embodiment of the invention.

### DETAILED DESCRIPTION OF DISCLOSED EMBODIMENTS

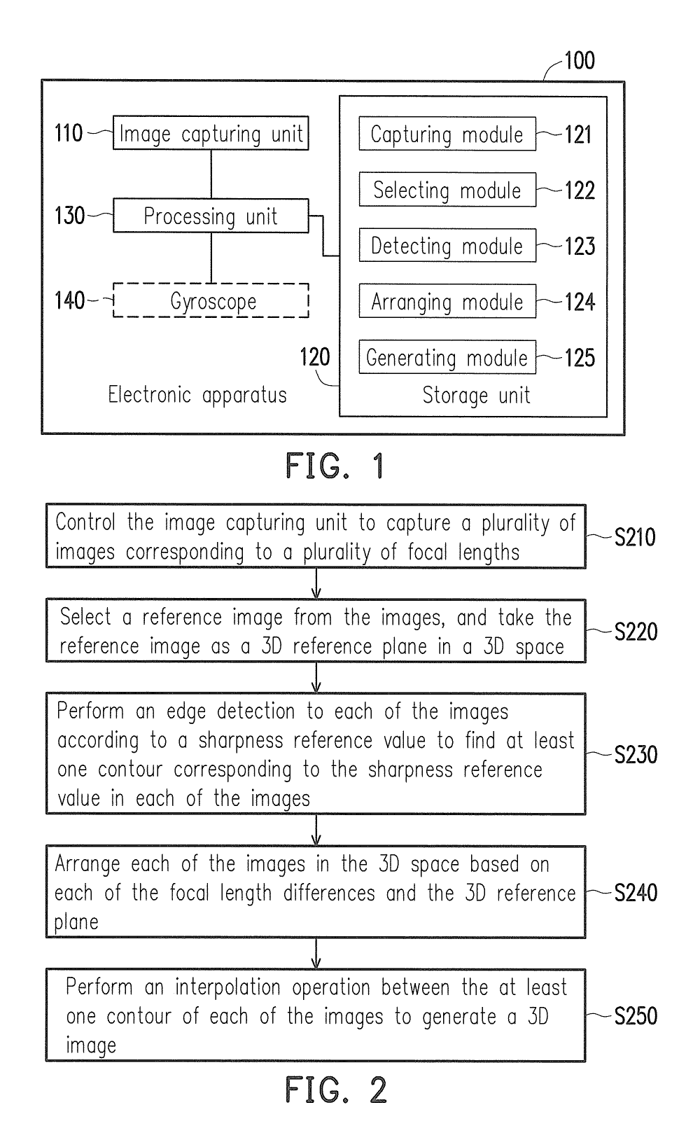

FIG. 1 is a schematic diagram of an electronic apparatus according to an embodiment of the invention. In the present embodiment, the electronic apparatus 100 can be a smart phone, a tablet personal computer (PC), a personal digital assistant (PDA), a notebook PC or other similar devices. The electronic apparatus 100 includes an image capturing unit 110, a storage unit 120 and a processing unit 130.

The image capturing unit 110 can be any camera having a charge coupled device (CCD) camera, a complementary metal oxide semiconductor transistors (CMOS) camera or an infrared camera, or can be an image capturing device capable of obtaining depth information, for example, a depth camera or a 3D camera. The storage unit 120 is, for example, a memory, a hard disk or any other device capable of storing data, which can be used for storing a plurality of modules.

The processing unit 130 is coupled to the image capturing unit 110 and the storage unit 120. The processing unit 130 can be a general purpose processor, a special purpose processor, a conventional processor, a digital signal processor, a plurality of microprocessors, one or a plurality of microprocessors combined with a digital signal processor core, a controller, a micro controller, an application specific integrated circuit (ASIC), a field programmable gate array (FPGA), any other types of integrated circuit, state machine, advanced RISC machine (ARM)-based processor and similar devices.

In the present embodiment, the processing unit 130 can access a capturing module 121, a selecting module 122, a detecting module 123, an arranging module 124 and a generating module 125 stored in the storage unit 120 to execute various steps of the method for generating a 3D image of the invention.

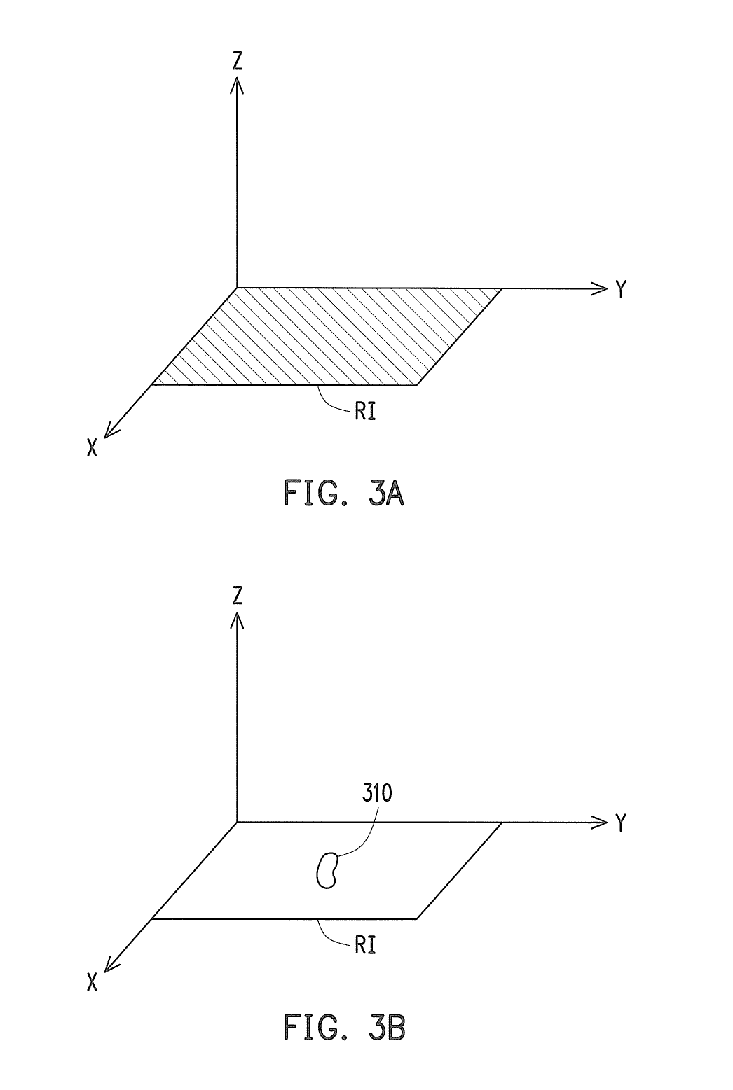

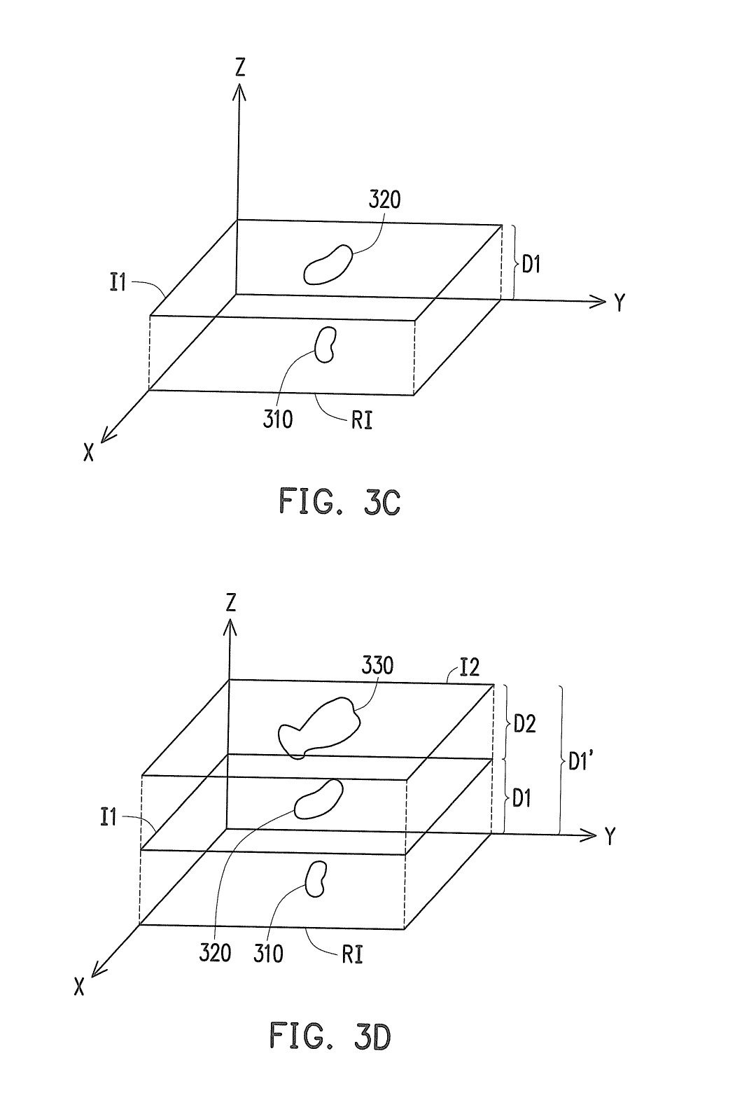

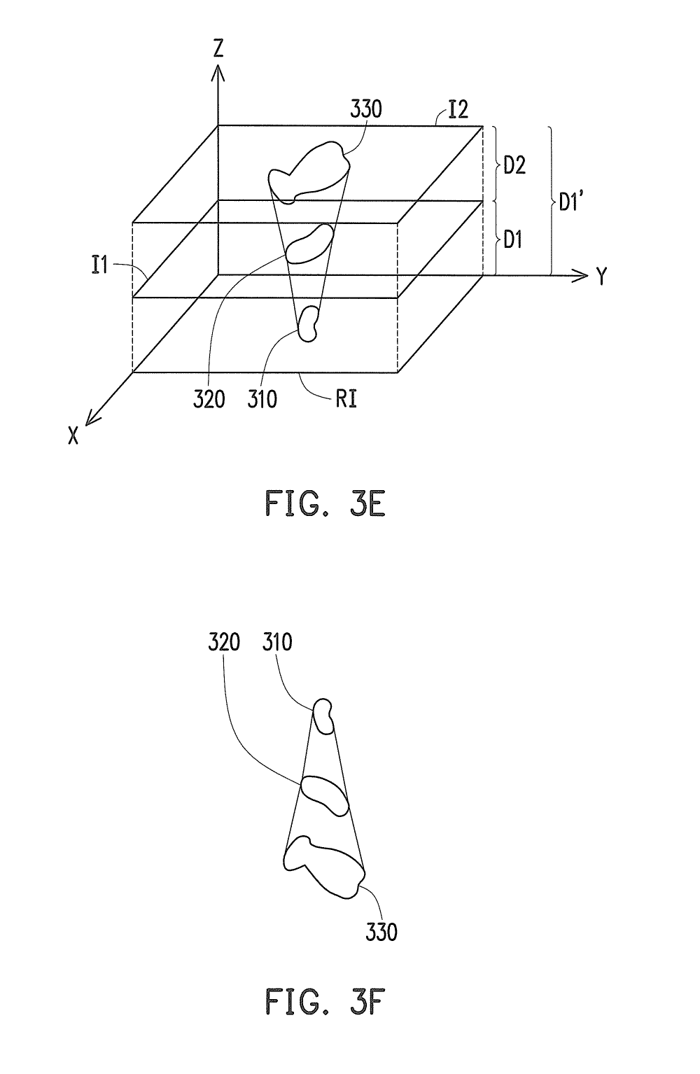

FIG. 2 is a flowchart illustrating a method for generating a 3D image according to an embodiment of the invention. FIG. 3A to FIG. 3F are schematic diagrams illustrating a process of generating a 3D image according to an embodiment of the invention. The method of the present embodiment can be executed by the electronic apparatus 100 of FIG. 1, and detailed steps of the method of the present embodiment are described below with reference of various components of FIG. 1.

In step 5210, the capturing module 121 controls the image capturing unit 110 to capture a plurality of images corresponding to a plurality of focal lengths. In detail, the image capturing unit 110 can capture a plurality of images of a same scene by using different focal lengths. Moreover, in order to ensure the method of the invention could be implemented in real-time, a time length that the image capturing unit 110 captures the images can be suitably adjusted by a designer, such as capturing 5 images within one second, etc. It should be noticed that the higher an image capturing speed of the electronic apparatus 100 is, the higher number of the images captured by the image capturing unit 110 is. Namely, the number of the images are proportional to the image capturing speed of the electronic apparatus 100, though the embodiment of the invention is not limited thereto.

In step S220, the selecting module 122 selects a reference image from the images, and takes the reference image as a 3D reference plane in a 3D space. The reference image is, for example, an image with a maximum focal length of the focal lengths in the images. In other words, the selecting module 122 can adopt a most clear image as the reference image (having the maximum focal length), though the embodiment of the invention is not limited thereto. The 3D space can be characterized by an X-axis, a Y-axis and a Z-axis, and the selecting module 122 can paste the reference image to an X-Y plane of the 3D space to define the 3D reference plane.

As shown in FIG. 3A, which is a schematic diagram of the 3D space after the selecting module 122 pastes the reference image RI to the X-Y plane. Alternatively, in other embodiments, the designer can also paste the reference image to any plane in the 3D space to define the 3D reference plane.

In step S230, the detecting module 123 performs an edge detection to each of the images according to a sharpness reference value to find at least one contour corresponding to the sharpness reference value in each of the images. The sharpness reference value is, for example, a value between 0 and 1 (for example, 0.3), which can be determined by the designer according to an actual requirement. After the sharpness reference value is determined, the detection module 123 can find the corresponding contours in each of the images.

It is assumed that the plurality of images include a first image, and the first image includes a plurality of pixels. The plurality of pixels include a first pixel and a second pixel adjacent to the first pixel, and the first pixel and the second pixel respectively have a first gray scale value and a second gray scale value. In order to describe the concept of the invention, in following descriptions, the first image is assumed to have a first focal length, and the first focal length is only smaller than the maximum focal length of the reference image, and first focal length and the maximum focal length has a first focal length difference there between.

When the detecting module 123 finds the contours in the first image corresponding to the sharpness reference value, regarding each of the adjacent first pixel and second pixel, the detecting module 123 calculates a difference between the first gray scale value and the second gray scale value. Moreover, when the difference is greater than a predetermined threshold value (for example, 30%), the detecting module 123 defines one of the first pixel and the second pixel as a contour pixel of the first image. Namely, when the detecting module 123 detects that the gray scale values of the adjacent pixels have a large variation, the detecting module 123 can determine that a boundary exists between the two pixels, and define one of the pixels (for example, the pixel having higher gray scale value) as the contour pixel. Thereafter, the detecting module 123 can find all of the contour pixels in the first image, so as to define one or a plurality of first contours in the first image. For example, the detecting module 123 can connect the adjacent or nearby contour pixels to form the contour, though the embodiment of the invention is not limited thereto.

Regarding the images other than the first image, those skilled in the art can find the contours corresponding to the sharpness reference value in each of the other images according to the aforementioned instructions, which would not be repeated herein. Referring to FIG. 3B, to facilitate description, the contour found from the reference image RI can be characterized by a reference contour 310.

Then, in step S240, the arranging module 124 arranges each of the images in the 3D space based on each of the focal length differences and the 3D reference plane. In detail, as shown in FIG. 3C, the arranging module 124 arranges the first image I1 in parallel to the reference image RI at a first position spaced from the reference image RI by a first focal length difference D1, where the arranged first image I1 is aligned to the reference image RI. It should be noticed that the first image I1 also includes a first contour 320 found by the detecting module 123.

It is assumed that the plurality of images further include a second image corresponding to a second focal length (which is smaller than the first focal length), and the second focal length and the first focal length have a second focal length difference there between, the arranging module 124 can arrange the second image in the 3D space according to the aforementioned mechanism.

Referring to FIG. 3D, the arranging module 124 arranges the second image I2 in parallel to the first image I1 at a second position spaced from the first image I1 by a second focal length difference D2, where the arranged second image I2 is aligned to the first image I1. As shown in FIG. 3D, the first image I1 and the second image I2 are located at a same side of the reference image RI, and a specific focal length difference DI′ between the second image I2 and the reference image RI is a sum of the first focal length difference D1 and the second focal length difference D2. It should be noticed that the second image I2 also includes a second contour 330 found by the detecting module 123.

Referring to FIG. 2 again, in step S250, the generating module 125 performs an interpolation operation between the at least one contour of each of the images to generate a 3D image. Referring to FIG. 3E, it is assumed that the reference contour 310, the first contour 320 and the second contour 330 all correspond to a same object (for example, a mountain) in the scene, the generating module 125 performs the interpolation operation between the first contour 320 and the reference contour 310 to connect the first contour 320 and the reference contour 310, and performs the interpolation operation between the second contour 330 and the first contour 320 to connect the second contour 330 and the first contour 320.

In brief, the electronic apparatus 100 converts the focal lengths corresponding to each of the images into Z-axis height information (i.e., each of the focal length differences) in the 3D space, and arranges the images to suitable positions in the 3D space according to the Z-axis height information. Then, the electronic apparatus 100 executes the interpolation operation between the contours in each of the images, so as to generate the 3D image shown in FIG. 3E.

It should be noticed that since the reference image RI used for determining the 3D reference plane is an image having the maximum focal length, when the 3D image in the 3E is presented to the user for viewing, the electronic apparatus 100 takes a negative Z-axis direction as the top of the 3D image (shown in FIG. 3F) other than taking a positive Z-axis direction as the top of the 3D image, though the embodiment of the invention is not limited thereto.

In other embodiments, the electronic apparatus 100 may further include a gyroscope 140 connected to the processing unit 130. Therefore, the processing unit 130 can rotate the 3D image according to a sensing signal of the gyroscope 140. In this way, the user can further feel a visual effect of the 3D image when viewing the 3D image.

In summary, in the method for generating the 3D image and the electronic apparatus using the same of the invention, after a plurality of images corresponding to different focal lengths are obtained, the images are suitably arranged in the 3D space according to the focal lengths. Then, the electronic apparatus executes the edge detection on each of the images to find the contours of each of the images, and executes the interpolation operation between the contours of each of the images to generate the 3D image corresponding to the captured images. In this way, even if the electronic apparatus is only configured with a single image capturing unit, it can still smoothly and easily generate the 3D image, so as to provide the user a new user experience.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for generating a three-dimensional (3D) image, adapted to an electronic apparatus, and comprising:
capturing a plurality of images corresponding to a plurality of focal lengths, where there are a plurality of focal length differences between the focal lengths;
selecting a reference image from the images, and taking the reference image as a 3D reference plane in a 3D space;
performing an edge detection to each of the images according to a sharpness reference value to find at least one contour corresponding to the sharpness reference value in each of the images;
arranging each of the images in the 3D space based on each of the focal length differences and the 3D reference plane; and
performing an interpolation operation between the at least one contour of each of the images to generate the 3D image.

2. The method for generating the 3D image as claimed in claim 1, wherein the images correspond to a same scene, and the reference image has a maximum focal length in the focal lengths.

3. The method for generating the 3D image as claimed in claim 2, wherein the images comprise a first image corresponding to a first focal length, there is a first focal length difference between the first focal length and the maximum focal length, the reference image comprises a reference contour corresponding to the sharpness reference value, and the step of arranging each of the images based on each of the focal length differences and the 3D reference plane comprises:
arranging the first image in parallel to the reference image at a first position spaced from the reference image by the first focal length difference, wherein the arranged first image is aligned to the reference image.

4. The method for generating the 3D image as claimed in claim 3, wherein the images further comprise a second image corresponding to a second focal length, there is a second focal length difference between the second focal length and the first focal length, and after the step of arranging the first image in parallel to the reference image at the first position spaced from the reference image by the first focal length difference, the method further comprises:
arranging the second image in parallel to the first image at a second position spaced from the first image by the second focal length difference, wherein the arranged second image is aligned to the first image,
wherein the first image and the second image are located at a same side of the reference image, and a specific focal length difference between the second image and the reference image is a sum of the first focal length difference and the second focal length difference.

5. The method for generating the 3D image as claimed in claim 3, wherein the first image comprises a first contour corresponding to the sharpness reference value, the reference image comprises a reference contour corresponding to the sharpness reference value, the first contour and the reference contour correspond to a first object, and the step of performing the interpolation operation between the at least one contour of each of the images to generate the 3D image comprises:
performing the interpolation operation between the first contour and the reference contour to connect the first contour and the reference contour.

6. The method for generating the 3D image as claimed in claim 5, wherein the images further comprises a second image, the second image comprises a second contour corresponding to the sharpness reference value, the second contour corresponds to the first object, and after the step of connecting the first contour and the reference contour, the method further comprises:
performing the interpolation operation between the second contour and the first contour to connect the second contour and the first contour.

7. The method for generating the 3D image as claimed in claim 1, wherein a number of the images is proportional to an image capturing speed of the electronic apparatus.

8. The method for generating the 3D image as claimed in claim 1, wherein the images comprise a first image, the first image comprises a plurality of pixels, the pixels comprise a first pixel and a second pixel adjacent to the first pixel, the first pixel has a first gray scale value, the second pixel has a second gray scale value, and the step of performing the edge detection to each of the images according to the sharpness reference value to find the at least one contour corresponding to the sharpness reference value in each of the images comprises:
calculating a difference between the first gray scale value and the second gray scale value;
defining one of the first pixel and the second pixel as a contour pixel of the first image when the difference is greater than a predetermined threshold value; and
finding all of the contour pixels in the first image, so as to define the at least one contour in the first image.

9. The method for generating the 3D image as claimed in claim 1, wherein after the step of generating the 3D image, the method further comprises:
rotating the 3D image according to a sensing signal of a gyroscope of the electronic apparatus.

10. An electronic device, adapted to generate a 3D image, and comprising:
an image capturing unit;
a storage unit, storing a plurality of modules; and
a processing unit, connected to the image capturing unit and the storage unit, and accessing and executing the modules, wherein the modules comprise:
a capturing module, controlling the image capturing unit to capture a plurality of images corresponding to a plurality of focal lengths, wherein there are a plurality of focal length differences between the focal lengths;
a selecting module, selecting a reference image from the images, and taking the reference image as a 3D reference plane in a 3D space;
a detecting module, performing an edge detection to each of the images according to a sharpness reference value to find at least one contour corresponding to the sharpness reference value in each of the images;
an arranging module, arranging each of the images in the 3D space based on each of the focal length differences and the 3D reference plane; and
a generating module, performing an interpolation operation between the at least one contour of each of the images to generate the 3D image.
